(19) United States
(12) Patent Application Publication
(10) Pub. No.: US 2010/0149202 A1
(43) Pub. Date: Jun. 17, 2010

(54) CACHE MEMORY DEVICE, CONTROL METHOD FOR CACHE MEMORY DEVICE, AND IMAGE PROCESSING APPARATUS

(75) Inventor: Kentaro Yoshikawa, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/623,805

(22) Filed: Nov. 23, 2009

(30) Foreign Application Priority Data
Dec. 17, 2008 (JP) 2008-321446

(51) Int. Cl. G09G 5/36

(52) U.S. Cl. 345/557

(57) ABSTRACT

A cache memory device includes a memory section configured to store image data of a frame with a predetermined size as one cache block, and an address conversion section configured to convert a memory address of the image data such that a plurality of different indices are assigned in units of the predetermined size in horizontal direction in the frame so as to generate address data, wherein the image data is output from the memory section as output data by specifying a tag, an index, and a block address based on the address data generated by the address conversion section through conversion.

### CROSS-REFERENCE TO RELATED APPLICATION

This application is based upon and claims the benefit of priority from the prior Japanese Patent Application No. 2008-321446 filed in Japan on Dec. 17, 2008; the entire contents of which are incorporated herein by reference.

### BACKGROUND OF THE INVENTION

1. Field of the Invention

The present invention relates to a cache memory device, a control method for a cache memory device, and an image processing apparatus, and more particularly to a cache memory device for storing image data of a frame, a control method for a cache memory device, and an image processing apparatus.

2. Description of Related Art

In television receivers for receiving terrestrial digital broadcasting, BS digital broadcasting, CS digital broadcasting and the like, or video recorders for reproducing video, image processing such as decoding is conventionally performed on image data.

For example, moving image data which is encoded by MPEG-4AVC/H.264 or the like is decoded and retained in frame memory as frame data. The frame data retained in the frame memory is utilized for decoding of image data of subsequent frames using a rectangular image in a predetermined area within the frame data as a reference image.

When a CPU or the like directly loads a reference image including a necessary image portion from the frame memory, e.g., SDRAM, data other than the necessary image data is also loaded. Of such data including an unnecessary portion that is loaded when a reference image is loaded, data other than the necessary image data is discarded, and even when the discarded data is required in immediately subsequent loading of another reference image, the data is loaded from the SDRAM again.

Japanese Patent Application Laid-Open Publication No. 2008-66913, for example, proposes a technique for improving cache hit rate when cache memory is used for readout of image data in image processing, because cache hit rate in image processing is low when general cache memory is utilized as-is for readout of a reference image from image data.

In an image data processing apparatus according to the proposal, multiple areas as readout units are defined in each of horizontal and vertical directions for making capacity of cache memory small and increasing cache hit rate.

In many of various types of general image processing, processing is sequentially performed from an upper left area of a frame to the right, and upon completion of processing at a rightmost end, processing is then sequentially performed from a left area immediately below to the right.

When such a way of processing is conducted, however, it is often a case that image data in an upper portion of an area in which pixels to be processed are present is already replaced with other image data and is no longer present in cache memory when reference should be made to the image data even when an index allocation method disclosed in the above proposal is employed. Conversely, the cache memory according to the proposal is not configured in consideration of a case where processing is sequentially performed from an upper left area of a frame to the right, and upon completion of processing at the rightmost end, processing is sequentially performed from the left area immediately below to the right.

### BRIEF SUMMARY OF THE INVENTION

According to an aspect of the present invention, there can be provided a cache memory device including a memory section configured to store image data of a frame with a predetermined size as one cache block, and an address conversion section configured to convert a memory address of the image data such that a plurality of different indices are assigned in units of the predetermined size in horizontal direction in the frame so as to generate address data, wherein the image data is output from the memory section as output data by specifying a tag, an index, and a block address based on the address data generated by the address conversion section through conversion.

### BRIEF DESCRIPTION OF THE DRAWINGS

FIG. 1 is a configuration diagram showing a configuration of an image processing apparatus according to a first embodiment of the present invention;

FIG. 2 is a diagram for illustrating an example of a unit for reading image data in one piece of frame data according to the first embodiment of the present invention;

FIG. 3 is a diagram for illustrating another example of a unit for reading image data in one piece of frame data according to the first embodiment of the present invention;

FIG. 4 is a configuration diagram showing an exemplary configuration of cache memory according to the first embodiment of the present invention;

FIG. 5 is a diagram for illustrating conversion processing performed in a conversion section according to the first embodiment of the present invention;

FIG. 6 is a diagram showing an example of layout of top field and bottom field data in SDRAM according to a second embodiment of the present invention;

FIG. 7 is a diagram showing another example of layout of top and bottom field data in SDRAM according to the second embodiment of the present invention;

FIG. 8 is a diagram for illustrating conversion processing performed in the conversion section according to the second embodiment of the present invention;

FIG. 9 is a diagram showing yet another example of layout of top and bottom field data in SDRAM according to the second embodiment of the present invention;

FIG. 10 is a diagram for illustrating conversion processing that is performed in the conversion section when top and bottom field data is arranged in the SDRAM as shown in FIG. 9;

FIG. 11 is a diagram for illustrating another example of conversion processing performed in the conversion section according to the second embodiment of the present invention;

FIG. 12 is a diagram for illustrating a unit for reading image data in one piece of frame data according to a third embodiment of the present invention; and

FIG. 13 is a configuration diagram showing a configuration of cache memory according to the third embodiment of the present invention.

### DETAILED DESCRIPTION OF THE INVENTION

Hereinafter, embodiments of the present invention will be described with reference to drawings.

### First Embodiment

### Configuration

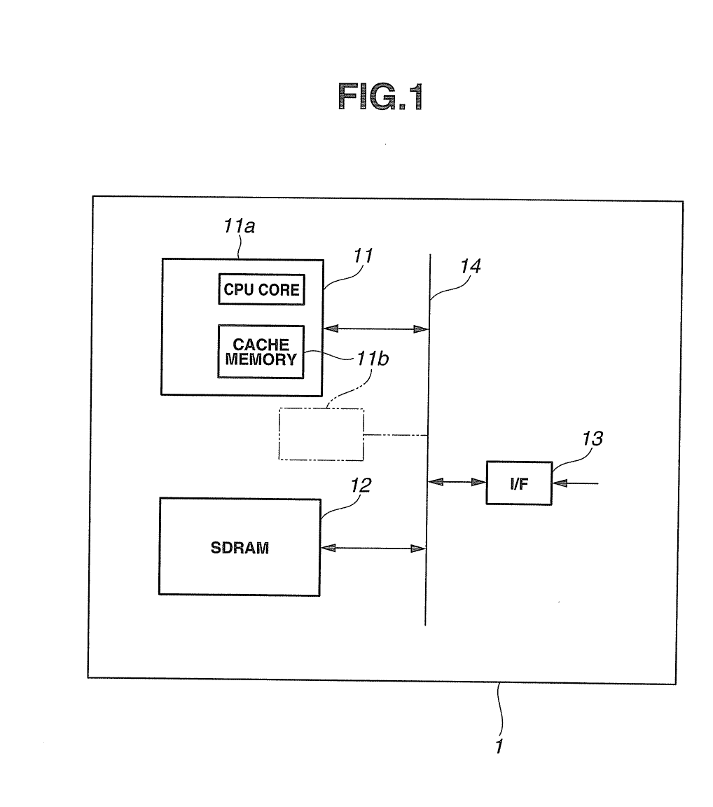

First, configuration of an image processing apparatus according to the present embodiment is described with respect to FIG. 1. FIG. 1 is a configuration diagram showing a configuration of the image processing apparatus according to the present embodiment.

A video processing apparatus 1, which may be a television receiver, a video decoder or the like, includes a central processing unit (CPU) 11 as an image processing section, a SDRAM 12 as main memory capable of storing multiple pieces of frame data, and an interface (hereinafter abbreviated as I/F) 13 for receiving image data. These components are interconnected via a bus 14. The CPU 11 has a CPU core 11a and a cache memory 11b.

The cache memory 11b is cache memory used for image processing, and although shown to be contained in the CPU 11 in FIG. 1, the cache memory 11b may also be connected with the bus 14 as indicated by a dotted line instead of being contained in the CPU 11.

Furthermore, while the CPU 11 is employed as an image processing section here, other circuit device, such as a dedicated decoder circuit, may be used.

The I/F 13 is a receiving section configured to receive broadcasting signals of terrestrial digital broadcasting, BS broadcasting and the like via an antenna or a network. Coded image data that has been received is stored in the SDRAM 12 via the bus 14 under control of the CPU 11. The I/F 13 may also be a receiving section configured to receive image data that has been recorded into a storage medium like a DVD, a hard disk device, and the like.

The CPU 11 performs decoding processing according to a predetermined method, such as MPEG-4AVC/H.264. That is to say, image data received through the I/F 13 is once stored in the SDRAM 12, and the CPU 11 performs decoding processing on the image data stored in the SDRAM 12 and generates frame data. In decoding processing, frame data is generated from image data stored in the SDRAM 12 while making reference to already generated frame data as necessary, and the generated frame data is stored in the SDRAM 12. In decoding processing, reference images in rectangular area units of a predetermined size in preceding and following frames, for example, are read from the SDRAM 12 and decoding is performed using the reference images according to a certain method. It means that data before decoding and decoded data are stored in the SDRAM 12.

At the time of decoding processing, the CPU 11 utilizes the cache memory 11b for reading image data of a reference image. By first accessing the cache memory 11b by the CPU core 11a of the CPU 11, memory band width is reduced and speed of reading out a reference image is increased. The CPU core 11a makes a data access to the SDRAM 12 by specifying a 32-bit memory address, for example. If data having the memory address is present in the cache memory 11b at the time, the data is read from the cache memory 11b. Configuration of the cache memory 11b is discussed later.

Next, data structure of image data stored in the SDRAM 12 will be described.

In the SDRAM 12, multiple pieces of coded frame data are stored, and in the cache memory 11b, image data for one frame divided into portions of a predetermined size is stored in each cache line, namely each cache block. Image data of the predetermined size corresponds to data in one cache block.

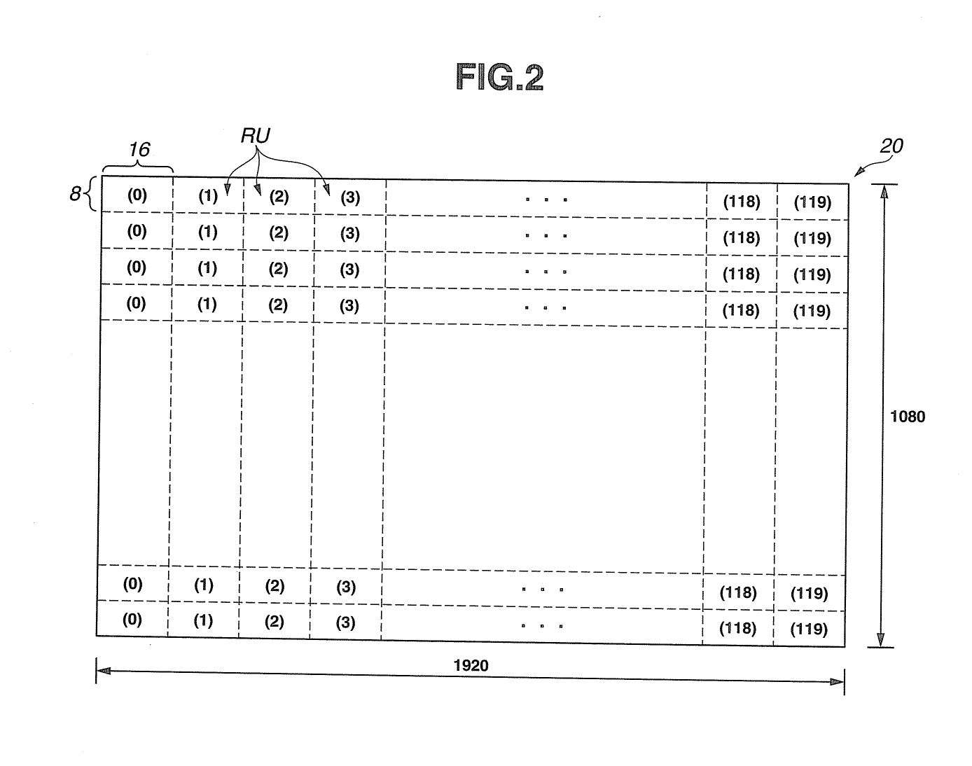

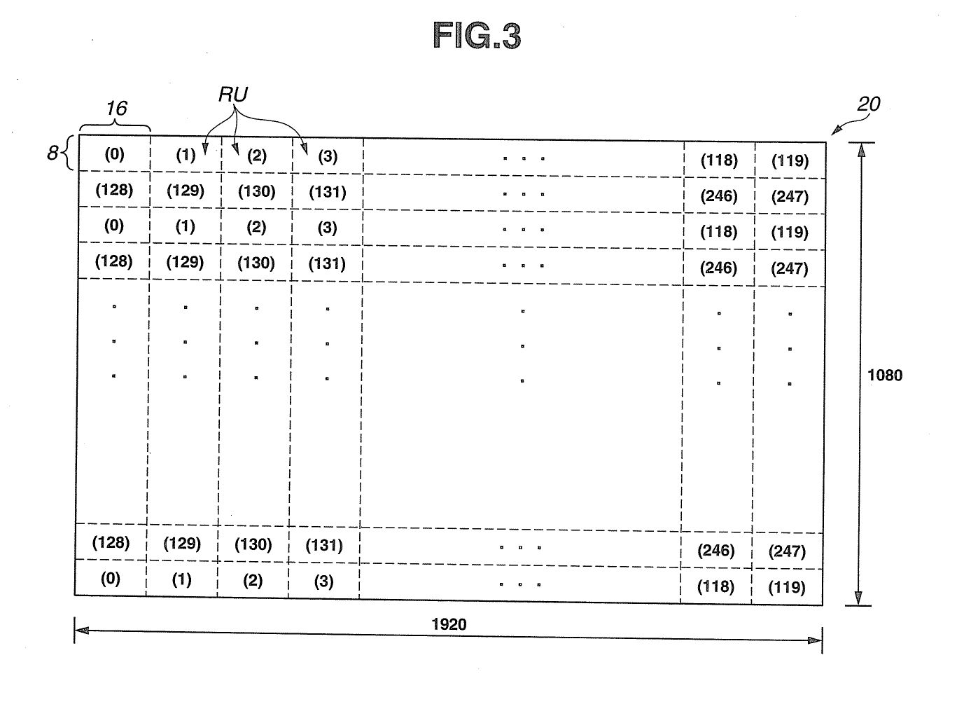

FIGS. 2 and 3 are diagrams for illustrating examples of units for reading image data in one piece of frame data.

One frame 20 is divided into multiple rectangular area units each of which is formed of image data of a predetermined size. Each of the rectangular area units represents one readout unit. The frame 20 is a frame that is made up of multiple pixels in a two-dimensional matrix, e.g., 1,920 by 1,080 pixels here. In other words, the frame 20 is a frame of 1,920 pixels wide and 1,080 pixels long. In the SDRAM12, data for multiple frames is stored. The CPU 11 is capable of decoding such 1,920-by-1,080 pixel image data.

The frame 20 is divided into matrix-like multiple rectangular area units RU, each of which is an image area as a readout unit, as shown in FIGS. 2 and 3. Each of the rectangular area units RU has a size of M by N pixels (M and N both being integers, where M>N), here, a size of 16 by 8 pixels, namely a size of 128 pixels consisting of 16 pixels widthwise and 8 pixels lengthwise, for example. Data of one pixel is one-byte data.

As one frame made up of 1,920 by 1,080 pixels is divided into matrix-like multiple rectangular area units RU each having a size of 16 by 8 pixels, the frame 20 is divided into horizontally 120 and vertically 135 rectangular area units RU as illustrated in FIGS. 2 and 3.

As described later, a cache data storage section (hereinafter called a memory section) in the cache memory 11b permits designation of a line or a cache block by means of an index.

Moreover, as described below, an index is assigned to each of multiple (here 120) rectangular area units RU of a frame that align widthwise. In FIG. 2, 120 rectangular area units RU to which index numbers from 0 to 119 are assigned constitute one block row. That is to say, an index is assigned to each rectangular area unit RU. One frame is composed of multiple rows in each of which multiple rectangular area units RU align. Hereinafter, a row will be also called a block row. Indices do not overlap among rectangular area units within a row, that is to say, indices are given uniquely in the horizontal direction within a frame.

Image data in units of the rectangular area unit RU of the predetermined size is stored in the cache memory 11b as one piece of cache block data, and image data for multiple rectangular area units RU of a frame is stored in the cache memory 11b. In other words, the memory section stores image data for a frame with the predetermined size as one cache block, and image data for one rectangular area unit RU (i.e., 128-pixel data) is stored in one cache block.

Processing for decoding is generally performed by scanning two-dimensional frame data widthwise. In the case of FIG. 2, image processing, such as decoding processing, is typically sequentially performed from an upper left area of frame data toward right areas, and when image processing on the rightmost area is completed, image processing is then sequentially performed from the left area immediately below toward right areas again. Therefore, cache hit rate is improved by associating image data with cache blocks and assigning indices as mentioned above with image data of the predetermined size as one cache block unit in each frame.

FIG. 2 shows that indices or index numbers in a range from 0 to 119 are assigned to multiple rectangular area units RU that horizontally (or widthwise) align in a frame. More specifically, in each of 135 rows (i.e., each of block rows), indices or index numbers are assigned to multiple rectangular area units RU such that the numbers are different from each other. And in one block row that includes 120 cache blocks, 120 index numbers are used.

FIG. 3 shows that indices or index numbers in ranges from 0 to 119 and from 128 to 247 are assigned to multiple rectangular area units RU that align horizontally (or widthwise) in a frame. Specifically, indices or index numbers are assigned to multiple rectangular area units RU such that the numbers are different from each other every two of the 135 rows (i.e., every two block rows). In other words, 240 index numbers are used in every two block rows in which 240 cache blocks align.

In both the cases of FIGS. 2 and 3, rectangular area units RU each have an index that is different from that of other rectangular area units within a block row (i.e., in multiple blocks of two-dimensional frame pixels that align widthwise, where M-by-N pixels represents one block), namely a unique index. Alternatively, each rectangular area unit RU has a unique index within multiple block rows (two block rows in FIG. 3).

FIG. 2 also shows a case where cache blocks have same indices lengthwise within a frame, and FIG. 3 shows a case where indices are the same lengthwise in every two or more consecutive block rows within a frame. In both the cases of FIGS. 2 and 3, however, indices are assigned so as to be different from each other among multiple rectangular area units RU that are at the same vertical position within a frame.

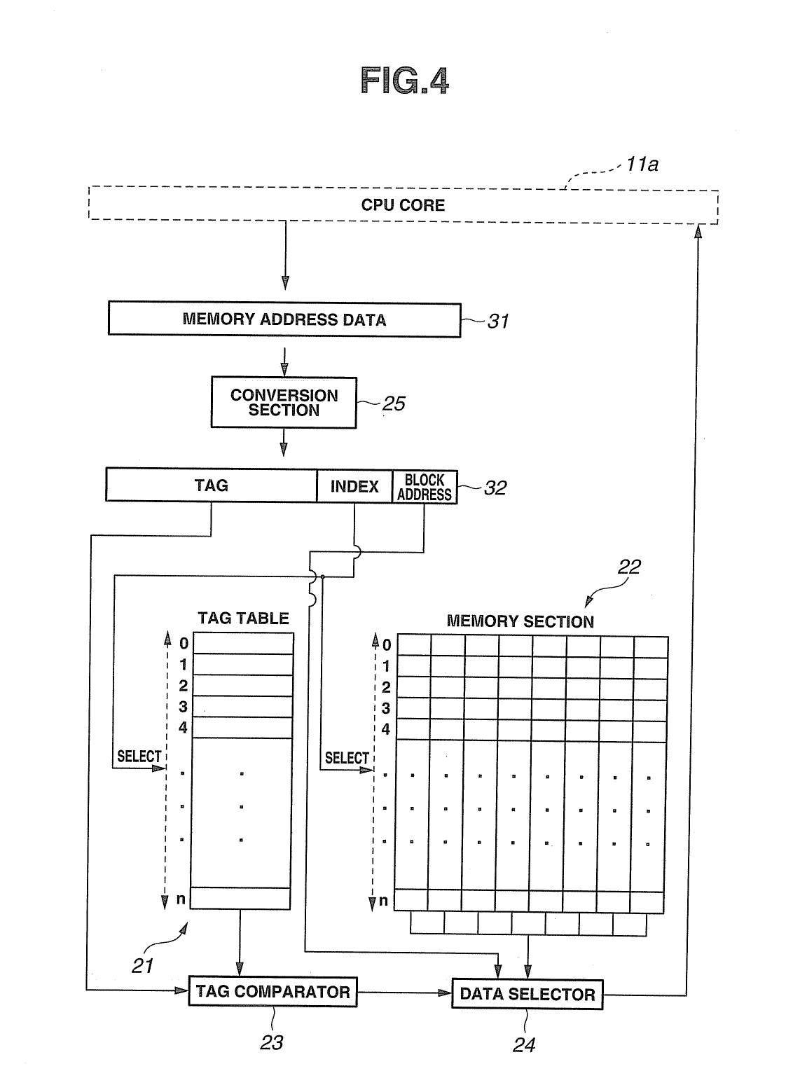

FIG. 4 is a configuration diagram showing an example of cache memory configuration.

The cache memory 11b includes a tag table 21, a memory section 22, a tag comparator 23, a data selector 24, and an address conversion section (hereinafter also called just a conversion section) 25. Memory address data 31 from the CPU core 11a is converted into address data 32 in the conversion section 25. Address conversion will be discussed later.

The cache memory 11b and the CPU core 11a are formed on a single chip as a system LSI, for example.

The tag table 21 is a table configured to store tag data corresponding to individual index numbers. Herein, index numbers are from 0 to n.

The memory section 22 is a storage section configured to store cache block data corresponding to individual index numbers. As mentioned above, the memory section 22 stores frame image data of the predetermined size as one cache block.

The tag comparator 23 as a tag comparison section is a circuit configured to compare tag data in the address data 32 that is generated by conversion of the memory address data 31 from the CPU core 11a with tag data in the tag table 21, and output a match signal as an indication of a hit when there is a match.

The data selector 24 as a data selection section is a circuit configured to select and output corresponding data in a selected cache block based on block address data in the address data 32. As shown in FIG. 4, upon input of a match signal from the tag comparator 23, the data selector 24 selects image data specified by a block address within a cache block that corresponds to a selected index, and outputs the image data as output data.

The conversion section 25 is a circuit configured to apply predetermined address conversion processing to the memory address data 31 from the CPU core 11a for replacing internal data as discussed below to convert the memory address data 31 into the in-cache address data 32 for the cache memory 11b. More specifically, the conversion section 25 generates the address data 32 by converting the memory address data 31 for image data so that multiple indices are assigned in units of the predetermined size horizontally in a frame.

The CPU core 11a outputs the memory address data 31 for data that should be read out, namely an address in the SDRAM 12, to the cache memory 11b. The memory address data 31 is 32-bit data, for example.

The conversion section 25 performs the aforementioned address conversion processing on the memory address data 31 that has been input or specified, and through specification of a tag, an index, and a block address based on the data after conversion, image data is output from the memory section 22 as output data to the CPU core 11a.

Since a block address is an address for specifying pixels in a rectangular area unit RU of M by N bits, each cache block is configured such that M>N. And the index 32b of the address data 32 includes data that indicates a horizontal position in a frame and at least a portion of data that indicates a vertical position in the frame.

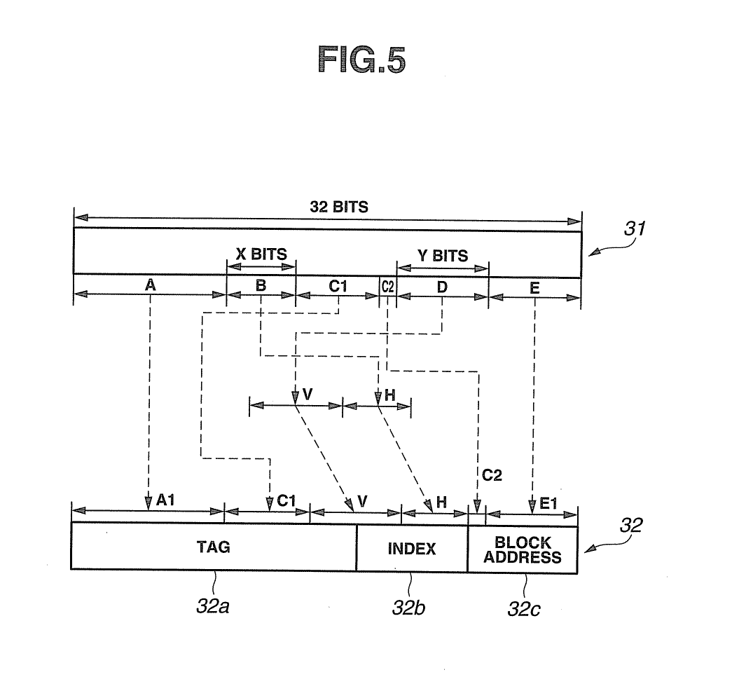

FIG. 5 is a diagram for illustrating conversion processing performed by the conversion section 25.

As mentioned above, the conversion section 25 converts the memory address data 31 into the address data 32. The memory address data 31 is 32-bit address data, and the address data 32 in the cache memory 11b is also 32-bit address data. The address data 32 is made up of a tag 32a, an index 32b, and a block address 32c.

Correspondence between the memory address data 31 and the address data after conversion 32 is as follows. A predetermined bit portion A on higher-order side in the memory address data 31 directly corresponds to a bit portion A1 on the higher-order side in the tag 32a of the address data 32. A predetermined bit portion E on lower-order side in the memory address data 31 directly corresponds to a bit portion E1 on the lower-order side in the block address 32c of the address data 32.

A bit portion B that neighbors the bit portion A on the lower-order side in the memory address data 31 corresponds to a bit portion H on the lower-order side in the index 32b of the address data 32, and corresponds to the bit portion H that indicates a horizontal position in the matrix of rectangular area units RU in a frame.

A bit portion D in the memory address data 31 that neighbors the bit portion E on the higher-order side corresponds to a bit portion V in the address data 32 that neighbors the bit portion H on the higher-order side, and corresponds to a bit portion V that indicates a vertical position in the matrix of rectangular area units RU in a frame.

A bit portion C between the bit portion B and the bit portion D in the memory address data 31 is divided into two bit portions, C1 and C2. The bit portion C1 corresponds to the bit portion between the bit portion A1 of the tag 32a and the bit portion V in the address data 32. The bit portion C2 corresponds to the bit portion between the bit portion E1 of the block address 32c and the bit portion H.

The conversion section 25 performs conversion processing for association as described above when data is written into the cache memory 11b and when data is read from the cache memory 11b.

### (Operations)

Operations of the cache memory 11b at the time of data readout in the present embodiment will be described.

When the memory address 31 is input from the CPU core 11a, such conversion processing as illustrated in FIG. 5 is performed in the conversion section 25 to generate the address data after conversion 32.

The tag comparator 23 of the cache memory 11b compares tag data stored in the tag table 21 that is specified by the index 32b in the address data 32 with tag data in the tag 32a, and outputs a match signal for indicating a hit to the data selector 24 if the two pieces of data match.

If the two pieces of data do not match, the tag comparator 23 returns a cache miss. Upon a cache miss, refilling is carried out.

The index 32b of the address data 32 is supplied to the memory section 22, and a cache block stored in the memory section 22 that is specified by the supplied index is selected and output to the data selector 24. Upon input of a match signal from the tag comparator 23, the data selector 24 selects data in the cache block that is specified by the block address 32c of the address data 32, and outputs the data to the CPU core 11a.

That is to say, as shown in FIG. 2 or 3, a frame is stored in the cache memory 11b in units of rectangular area units RU to which index numbers that are unique within a block row are assigned. And since index numbers are assigned such that the numbers do not overlap horizontally in a frame, that is to say, are uniquely assigned, once a cache block of a certain index has been read out and stored in the cache memory 11b, a cache miss is less likely to occur when a frame is read out as a reference image.

As described above, according to the present embodiment, indices are uniquely assigned to multiple blocks that align in horizontal direction with M-by-N pixel image data as one cache block in a two-dimensional frame. Accordingly, since all data in horizontal direction of a frame can be cached in the cache memory, cache hit rate is increased in decoding processing on an image processing apparatus in which image processing is often performed in order of raster scanning, such as a video decoder.

### Second Embodiment

While the above-described video processing apparatus according to the first embodiment is an apparatus for processing non-interlaced images, a video processing apparatus according to a second embodiment of the present invention is an example of an apparatus that processes interlaced images. A cache memory device of the video processing apparatus according to the present embodiment is configured to store data in a memory section such that data for top field and data for bottom field of an interlaced image are not present together within a cache block. Such a configuration reduces occurrence frequency of cache misses.

As the video processing apparatus has a similar configuration to that of the apparatus shown in FIGS. 1 and 4, the same components are denoted with the same reference numerals and descriptions of such components are omitted.

### (Configuration)

Since some of various types of image processing for an interlaced image use only top field data, for example, cache misses would occur with a high frequency if top field data and bottom field data are present together in a cache block. Thus, in the present embodiment, data is stored such that only either top or bottom field data is present in each cache block of the cache memory.

In other words, in the SDRAM 12, top field data and bottom field data are stored in any of various layouts, whereas in the cache memory 11b, data is stored such that only either the top or the bottom field of data of a frame stored in the SDRAM 12 is present in each cache block.

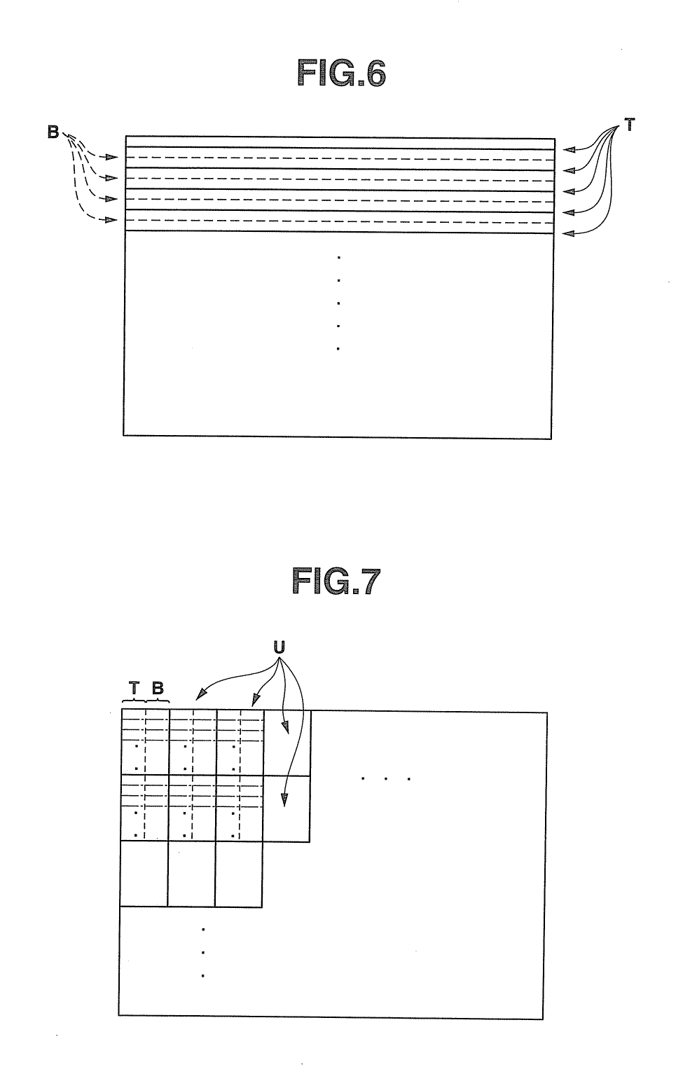

FIGS. 6 and 7 are diagrams showing examples of layout of top and bottom field data in the SDRAM 12. In FIGS. 6 and 7, solid lines denote pixel data of top field and broken lines denote pixel data of bottom field.

In the case of FIG. 6, image data is stored in the SDRAM 12 in the same pattern as a displayed image for a frame. In the case of FIG. 7, image data is stored in the SDRAM 12 in a format different from positions of individual pixels of a displayed image for a frame. FIG. 7 shows that top field data and bottom field data are stored together in each predetermined unit, U.

In the case of FIG. 6, for example, one row of a frame, namely, each piece of 1,920-pixel data, is represented in 11 bits, and one bit for indicating whether the row is top or bottom field is further added to the represented data, being represented as image data.

The address conversion section 25 applies address conversion processing described below to each piece of pixel data of FIGS. 6 and 7 for each frame, and image data in the converted format is stored in the cache memory 11b according to the present embodiment. When data is stored into the memory section 22 of the cache memory 11b and when data is read from the memory section 22, the memory address data 31 is converted into the address data 32A by the conversion section 25 and an access is made to the memory section 22. And only either top or bottom field data is present in each cache block.

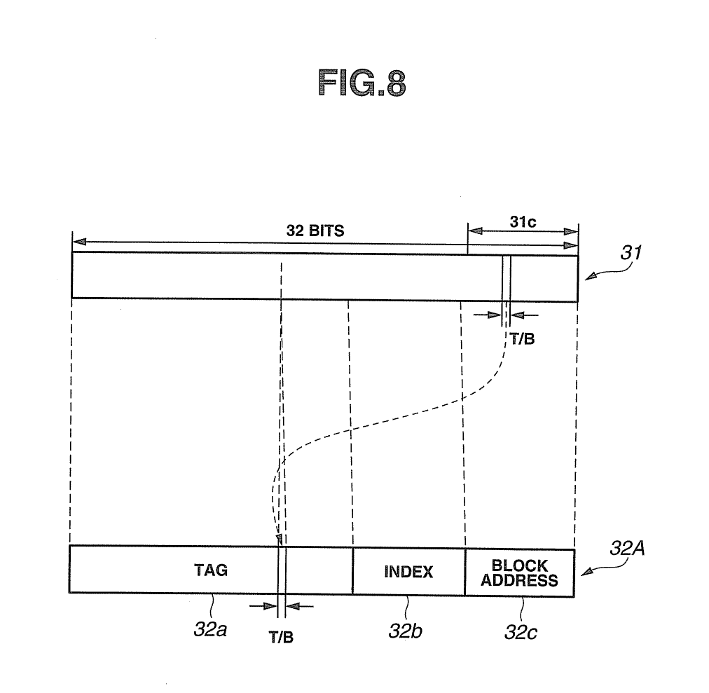

FIG. 8 is a diagram for illustrating conversion processing performed by the conversion section 25 of the present embodiment.

The conversion section 25 converts the memory address data 31 into the address data 32A. As in the first embodiment, the memory address data 31 is 32-bit address data and the address data 32A in the cache memory 11b is also 32-bit address data. The address data 32A is made up of a tag 32a, an index 32b, and a block address 32c.

In the present embodiment, correspondence between the memory address data 31 and the address data after conversion 32A is as follows. The conversion section 25 performs address conversion processing such that a bit portion T/B made up of one bit, or two or more bits which is included on the lower-order side in the 32-bit data of the memory address data 31 as indication data for showing distinction between top and bottom field is moved to and included at a predetermined position in the tag 32a of the address data after conversion 32A. In the case of FIG. 8, the bit portion T/B which is data indicative of field polarity is present in a portion corresponding to the block address 32c, namely in a data portion 31c of the memory address data 31. That is to say, by performing conversion processing so as to move the bit portion T/B to a position higher in order than the index 32b, only either top or bottom field data is present in a cache block.

As shown in FIG. 8, the address data 32A is data that is formed by moving the bit portion T/B to a predetermined bit position in the tag 32a. A bit portion on the higher-order side of the bit portion T/B in the tag 32a is the same as higher-order bits of the memory address data 31, and a bit portion on the lower-order side of the bit portion T/B in the tag 32a is the same as lower-order bits of the memory address data 31 excluding the T/B portion.

Furthermore, as in the first embodiment, index numbers are uniquely assigned in each of top and bottom fields within each block row of a frame as shown in FIG. 2 or 3. In other words, index numbers are assigned so that the numbers do not overlap lengthwise, i.e., are uniquely assigned, in each of top and bottom fields of a frame.

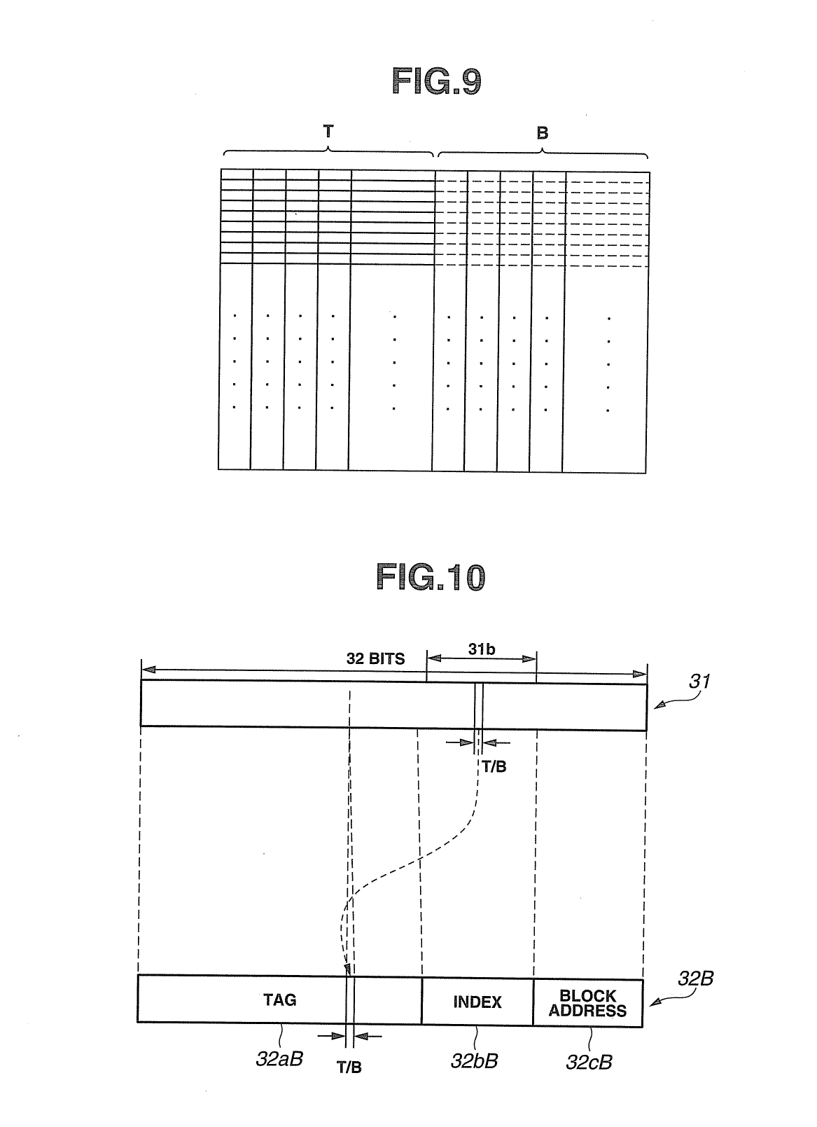

FIG. 9 is a diagram showing yet another example of layout of top and bottom field data in the SDRAM 12. In FIG. 9, solid lines denote pixel data of top field and broken lines denote pixel data of bottom field.

FIG. 9 shows that top field data and bottom field data are stored together in the SDRAM 12 in a format different from that of a display image for a frame.

In the layout of FIG. 9, the bit portion T/B is present in a portion corresponding to the index of the address data after conversion 32B, namely in the data portion 31b of the memory address data 31. In such a case, only top or bottom field could possibly be allocated to a particular index. In processing that uses only top field in certain image processing, cache memory might be used with only half of indices used, for example, in which case a problem of the capacity of the cache memory being virtually halved will be encountered. Thus, when the bit portion T/B is present in the data portion 31b of the memory address data 31 that corresponds to the index of the address data after conversion 32B, the conversion section 25 performs such address conversion as illustrated in FIG. 10 to prevent occurrence of the problem.

FIG. 10 is a diagram for illustrating conversion processing performed in the conversion section 25 when top and bottom field data is arranged in the SDRAM 12 as shown in FIG. 9.

The conversion section 25 converts the memory address data 31 into the address data 32B. As in the first embodiment, the memory address data 31 is 32-bit address data and the address data 32B in the cache memory 11b is also 32-bit address data. The address data 32B is made up of a tag 32aB, an index 32bB, and a block address 32cB.

In the present embodiment, correspondence between the memory address data 31 and the address data after conversion 32B is as follows. The conversion section 25 performs conversion processing to move a bit portion T/B made up of one bit, or two or more bits which is present in the data portion 31b to a predetermined position in the tag 32aB of the address data 32B. The bit portion T/B is present in the data portion 31b of the memory address data 31 that corresponds to the index 32bB. That is to say, also by performing conversion processing so as to move the bit portion T/B which is data indicative of field polarity to the higher-order side of the index 32bB, only either top or bottom field data is present in each cache block and such a situation is prevented in which cache capacity is virtually only partially used. In other words, a cache block corresponding to an index contains only either top or bottom field data, and all of available indices can be used even during processing that uses only the top field, for example.

As shown in FIG. 10, the address data 32B is data formed by moving the bit portion T/B to a predetermined bit portion in the tag 32aB. A bit portion on the higher-order side of the bit portion T/B in the tag 32aB is the same as higher-order bits of the memory address data 31, and a bit portion on the lower-order side of the bit portion T/B in the tag 32aB is the same as lower-order bits of the memory address data 31 excluding the T/B portion.

In the case of FIG. 10, the cache memory 11b does not manage separate areas, such as a data area for top field and a data area for bottom field, but cache blocks are allocated to both the fields without distinction between the two types of field data.

Since the bit portion T/B is sometimes represented in two or more bits as mentioned above, the bit portion T/B can be present in both portions corresponding to the index and the block address of the address data after conversion 32, namely in both the data portions 31b and 31c of the memory address data 31.

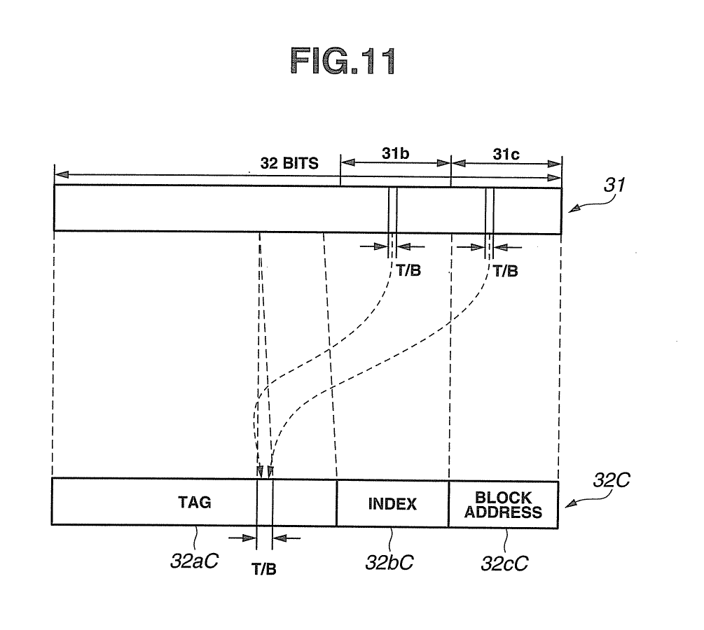

In such a case, address conversion may be performed as shown in FIG. 11. FIG. 11 is a diagram for illustrating another example of conversion processing performed by the conversion section 25.

As illustrated in FIG. 11, the conversion section 25 performs conversion processing to combine two bit portions T/B present in the data portions 31b and 31c of the memory address data 31 and move the combined bit portion to a predetermined position in the tag 32aC of the address data after conversion 32C.

### (Operations)

Operations of the cache memory 11b at the time of data readout in the present embodiment are similar to those of the cache memory 11b of the first embodiment and are different only in that conversion processing performed in the conversion section 25 is such conversion processing as illustrated in FIG. 8, 10, or 11.

As described above, for an interlaced image of a field structure, decoding processing is carried out separately on top field and bottom field. Therefore, if the two types of field data are present together in a cache block, data of both the fields will be read into the cache even when only data for either one of the fields is required, which decreases cache efficiency.

According to the above-described cache memory device 11b of the present embodiment, cache efficiency does not decrease because only either top or bottom field data is stored in each cache block.

Also, even if only data for either one of the two fields is required when individual cache blocks are allocated in a manner that the cache blocks are used for only either the top or bottom field, cache blocks allocated to data of the other field would not be used at all, which decreases cache efficiency. Thus, by adopting such an index allocation method as illustrated by FIG. 10, decrease in cache efficiency can be prevented.

Thus, according to the present embodiment, cache hit rate for image data in decoding processing is improved even for interlaced frames on an image processing apparatus in which image processing is often done in order of raster scanning, such as a video decoder.

### Third Embodiment

### Configuration

Now, a third embodiment of the present invention will be described.

Decoding processing can include processing in which the area of a referenced image is changed in accordance with the type of processing during decoding processing. One of such types of processing is processing that includes adaptive motion predictive control, e.g., Macro Block Adaptive Frame/Field (MBAFF) processing in MPEG-4AVC/H.264.

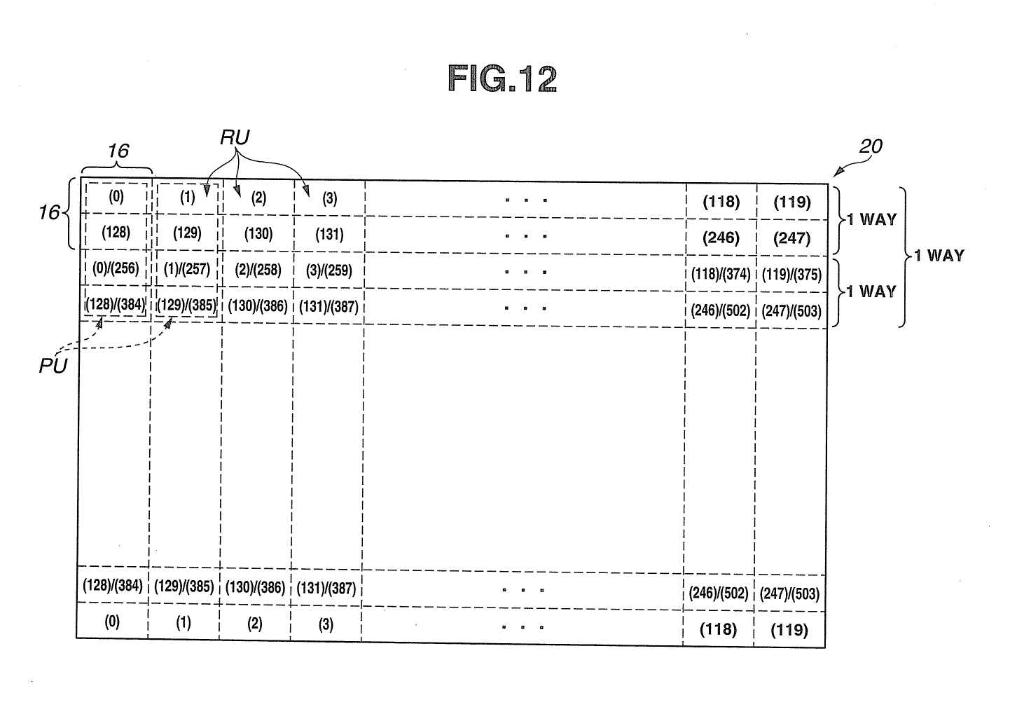

FIG. 12 is a diagram for illustrating a unit for readout of image data from one piece of frame data in the present embodiment.

In FIG. 12, one frame 20 is divided into multiple areas each of which is composed of 16 by 16 pixels. In general image processing, image data is read out and subjected to various ways of processing with each one of the areas as one processing unit (i.e., a macroblock unit).

In a particular way of processing, e.g., the MBAFF processing mentioned above, however, image processing may be performed with 16 by 32 pixels as a processing unit. In the case of FIG. 12, during a certain way of image processing, address conversion for the cache memory 11b is performed in the 16-by-16 pixel processing unit as described in the first or second embodiment, but at the time of processing that involves change to the pixel area of the processing unit, e.g., MBAFF processing, image processing is performed in a processing unit, PU, of 16 by 32 pixels.

To further improve cache hit rate in such a case, the present embodiment changes a number of ways in the cache memory in accordance with the type of image processing, more specifically, change in the pixel area of the processing unit. To be specific, when the processing unit has changed to the processing unit PU, the number of ways is decreased in the cache memory 11b in order to increase the number of indices so as to conform to the processing unit PU.

As a result, in the case of FIG. 12, a state in which one way corresponds to two block rows is changed to a state in which one way corresponds to four block rows. More specifically, numbers from 0 to 119, from 128 to 247, from 256 to 375, and from 384 to 503 are assigned as index numbers, so that the number of index numbers doubles while the number of ways in the cache memory reduces to the half. That is to say, when the processing unit for image processing has become larger, like in MBAFF processing mode, the configuration of the cache memory 11b is changed so as to decrease the number of ways and increase the number of indices.

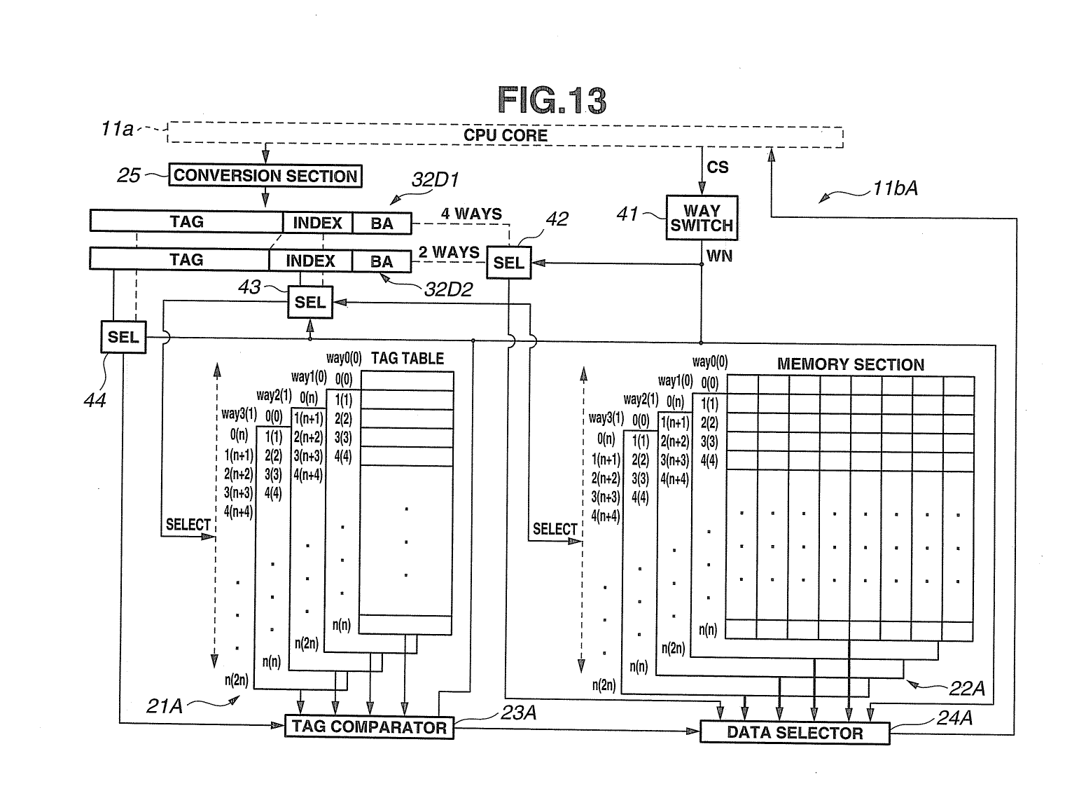

FIG. 13 is a configuration diagram showing a configuration of cache memory according to the present embodiment. By way of example, in an image processing apparatus including a CPU core as an image processing section and cache memory 11bA as a cache memory device, the cache memory 11bA is a set-associative cache memory device that is capable of changing the number of ways in accordance with processing unit granularity of a CPU.

The cache memory 11bA shown in FIG. 13 includes a way switch 41 and three selector circuits 42, 43 and 44 in addition to the configuration of the cache memory 11b shown in FIG. 4.

The conversion section 25 performs the address conversion processing described in the first or second embodiment. Address data after address conversion is maintained in a register as two pieces of data, D1 and D2, in accordance with the number of indices associated with change of the number of ways as discussed later.

When the aforementioned MBAFF processing which involves lengthwise expansion of the processing unit area in a frame is executed, a predetermined control signal CS for changing the number of ways is supplied from the CPU core 11a to the way switch 41. Upon input of the predetermined control signal CS, the way switch 41 outputs a way-number signal WN which indicates the number of ways after change to each of the selectors 42, 43 and 44. The control signal CS is a signal that indicates a change of the pixel area of the processing unit.

The selector 42 outputs the block address (BA) of one piece of address data selected from multiple pieces of address data (two pieces of address data here) in accordance with the way-number signal WN to the data selector 24A. In the case of FIG. 13, the address data 32D1 corresponds to four ways and the address data 32 D2 corresponds to two ways. The address data 32D2 is address data that contains an index with a greater number of indices than the address data 32D1.

The selector 43 outputs the index number of one piece of address data selected from multiple pieces of address data (two pieces of address data here) in accordance with the way-number signal WN to the tag table 21A and the memory section 22A.

The selector 44 outputs the tag of one piece of address data selected from multiple pieces of address data (two pieces of address data here) in accordance with the way-number signal WN to the tag comparison section 23A.

As shown above, the way switch 41 receives the predetermined control signal CS from the CPU core 11a and outputs the way-number signal WN to each of the selectors (SEL). The predetermined control signal CS is a processing change command or data that indicates a change in processing state, and in the present embodiment, the control signal CS is data indicating that a general image processing state has been changed to a processing state like MBAFF processing or indicating the MBAFF processing state.

Change of the number of ways and change of index numbers are made by changing assignment to multiple storage areas in the cache memory 11bA.

### (Operations)

Operations of the cache memory 11bA of FIG. 13 will be described.

When image processing has been changed to processing that involves change to the processing unit, e.g., MBAFF processing, during operation of the video processing apparatus 1 shown in FIG. 1, the CPU core 11a outputs the control signal CS to the cache memory 11bA. By way of example, assume that the cache memory 11bA has been operating with four ways until reception of the control signal CS.

Upon the cache memory 11bA receiving the control signal CS, the way switch 41 outputs the way-number signal WN (=2) to the selectors 42, 43 and 44 for changing the number of ways to two.

Then, the selector 42 selects the block address (BA) of address data 32D2 that corresponds to two ways from the two pieces of address data 32D1 and 32D2, and outputs the address to the data selector 24A.

The selector 43 selects the index number of the address data 32D2 that corresponds to two ways, and outputs the index number to the tag table 21A and the memory section 22A.

The selector 44 selects the tag of address data 32D2 that corresponds to two ways, and outputs the tag to the tag comparison section 23A.

As a result, the memory section 22A outputs output data with the index and block address (BA) specified based on the address data 32D2 containing an index with an increased number of indices, so that the number of indices is increased as described in FIG. 12 and cache hit rate improves.

Thereafter, when image processing has shifted to processing that was being executed before the MBAFF processing or another type of processing, the control signal CS becomes a signal that indicates MBAFF processing is no longer being performed. As a result, the cache memory 11bA returns the number of ways from two to four and the number of indices to the number from 1 to 119 and from 128 to 247, which were originally used. The selectors select the address data 32D1 and respectively output the block address (BA), index, and tag of the address data 32D1.

As has been described, during MBAFF processing, the present embodiment halves the number of ways to thereby double the number of indices or allocates two block rows of 16 by 16 pixels to one way.

Thus, the number of ways in each of the tag table 21A and the memory section 22A is changed in accordance with a change to the number of ways, resulting in an increased number of indices in the tag table 21A and the memory section 22A. Accordingly, cache hit rate can be improved even during processing in which the pixel area of the processing unit expands in the vertical (or lengthwise) direction in a frame.

In general, cache hit rate of cache memory is improved by increasing the number of ways. However, when the processing unit for image processing becomes large as described above, cache hit rate can be increased by decreasing the number of ways to increase indices.

As described above, according to the present embodiment, when two cache memories have the same cache capacity and number of bytes per cache block, the number of indices of cache blocks becomes large when the number of ways is small and the number of indices becomes small when the number of ways is large. Therefore, with regard to image processing, indices can be uniquely assigned over a wide range of an image when the number of ways is small, and the opposite when the number of ways is large. Cache memory is efficiently utilized to improve cache hit rate by reducing the number of ways to keep data for a wide range of an image within cache when access granularity to image data is high and increasing the number of ways to flexibly replace data for a small range of an image when access granularity is low.

Especially data coded using MBAFF processing of MPEG-4AVC/H.264 is processed by concurrently using two macroblocks in the vertical direction, meaning that the pixel area of processing unit of an image to be decoded is large or wide compared to when MBAFF processing is not used. Accordingly, access granularity to a reference image and the like also become large. Therefore, for stream data using MBAFF processing, cache memory can be utilized more efficiently in some cases by making the number of ways smaller than that for general stream data.

As has been described, according to the above-described embodiments, cache hit rate can be improved in a cache memory device that stores image data.

The present invention is not limited to the above-described embodiments and various changes and modifications are possible without departing from the scope of the invention.

What is claimed is:

1. A cache memory device, comprising:
a memory section configured to store image data of a frame with a predetermined size as one cache block; and
an address conversion section configured to convert a memory address of the image data such that a plurality of different indices are assigned in units of the predetermined size in horizontal direction in the frame so as to generate address data,
wherein the image data is output from the memory section as output data by specifying a tag, an index, and a block address based on the address data generated by the address conversion section through conversion.

2. The cache memory device according to claim 1, further comprising:
a tag table configured to store a plurality of tags corresponding to the plurality of indices;
a tag comparator configured to compare a tag in the tag table corresponding to a selected index with the tag of the address data and output a match signal if the two tags match; and
a data selector configured to, in response to output of the match signal, select image data that is in a cache block corresponding to the selected index and specified by the block address and output the image data as the output data.

3. The cache memory device according to claim 1, wherein the address conversion section converts the memory address into the address data so that the index includes data which indicates a horizontal position in the frame.

4. The cache memory device according to claim 3, wherein the index includes at least a portion of data that indicates a vertical position in the frame.

5. The cache memory device according to claim 1, wherein the address conversion section has the image data be separated into a top field and a bottom field to be stored in the memory section.

6. The cache memory device according to claim 5, wherein the address conversion section converts the memory address so that top/bottom indication data in the memory address that shows distinction between the top field and the bottom field is included in the tag of the address data.

7. The cache memory device according to claim 6, wherein the top/bottom indication data is included in the memory address at a portion corresponding to the index of the address data or a portion corresponding to the block address of the address data.

8. The cache memory device according to claim 7, wherein the top/bottom indication data is included in the memory address at both the portions corresponding to the index and the block address of the address data.

9. The cache memory device according to claim 1, further comprising a way switching section configured to change a number of ways in the memory section in accordance with a change in a pixel area of a predetermined processing unit.

10. The cache memory device according to claim 9, wherein
the change in the pixel area is a change that expands the pixel area in vertical direction in the frame, and
the change of the number of ways in the memory section is a change to decrease the number of ways.

11. The cache memory device according to claim 10, wherein upon the way switching section receiving a signal that indicates a change in the pixel area of the predetermined processing unit, the memory section outputs the output data with the index and the block address specified based on the address data that includes the index having an increased number of indices.

12. A control method for a cache memory device comprising a memory section, the method comprising:
storing image data of a frame in the memory section with a predetermined size as one cache block;
converting a memory address of the image data such that a plurality of different indices are assigned in units of the predetermined size in horizontal direction in the frame so as to generate address data; and
outputting the image data from the memory section as output data by specifying a tag, an index, and a block address based on the address data generated through conversion.

13. The control method for a cache memory device according to claim 12, wherein the memory address is converted into the address data so that the index includes data which indicates a horizontal position in the frame.

14. The control method for a cache memory device according to claim 13, wherein the index includes at least a portion of data that indicates a vertical position in the frame.

15. The control method for a cache memory device according to claim 12, wherein the image data is stored in the memory section being separated into a top field and a bottom field.

16. The control method for a cache memory device according to claim 15, wherein the memory address is converted so that top/bottom indication data in the memory address that shows distinction between the top field and the bottom field is included in the tag of the address data.

17. The control method for a cache memory device according to claim 16, wherein the top/bottom indication data is included in the memory address at a portion corresponding to the index of the address data or a portion corresponding to the block address of the address data.

18. The control method for a cache memory device according to claim 17, wherein the top/bottom indication data is included in the memory address at both the portions corresponding to the index and the block address of the address data.

19. The control method for a cache memory device according to claim 12, wherein a number of ways in the memory section is changed in accordance with a change in a pixel area of a predetermined processing unit.

20. An image processing apparatus, comprising:
a cache memory device, comprising a memory section configured to store image data of a frame with a predetermined size as one cache block; and an address conversion section configured to convert a memory address of the image data such that a plurality of different indices are assigned in units of the predetermined size in horizontal direction in the frame so as to generate address data, wherein the image data is output from the memory section as output data by specifying a tag, an index, and a block address based on the address data generated by the address conversion section through conversion;
a main memory capable of storing the image data of the frame; and
an image processing section configured to read the image data from the main memory via the cache memory device and perform image processing on the image data.
